(19) United States
(12) Patent Application Publication
(10) Pub. No.: US 2010/0183487 A1
(43) Pub. Date: Jul. 22, 2010

(54) HIGHLY HEAT INTEGRATED FUEL PROCESSOR FOR HYDROGEN PRODUCTION

(76) Inventors: Xenophon Verykios, Vassilios Ahaias (GR); Dimitrios K. Lygouras, Platani Ahaias (GR)

Correspondence Address: HOFFMANN & BARON, LLP, 6900 JERICHO TURNPIKE, SYOSSET, NY, 11791, US

(21) Appl. No.: 12/666,076

(22) PCT Filed: Apr. 22, 2008
(86) PCT No.: PCT/GR08/00028

§ 371 Date: Mar. 24, 2010

(30) Foreign Application Priority Data
May 25, 2007 (GR) 20070100315

(51) Int. Cl. B01J 19/00

(52) U.S. Cl. 422/188

(57) ABSTRACT

Described herein is a highly heat integrated fuel processor assembly that can be used for hydrogen production from a fuel source. The assembly comprises a heat exchanger type integrated reformer/combustor sub-assembly 51 also including catalyst able to induce the reforming and the combustion reaction. The fuel processor also comprises a high temperature WGS reactor 52, a low temperature WGS reactor 53 and a selective CO oxidation or methanation reactor 54 so that the train of reactors can maximize hydrogen production and minimize the CO concentration of the product. The fuel processor further comprises a series of steam generators and heat exchangers that enhance the heat integration of the fuel processor. The whole fuel processor assembly or sub-assemblies can be employed for highly efficient distributed hydrogen generation.

### FIELD OF THE INVENTION

This invention relates to fuel processors for distributed hydrogen production and more particular to fuel processors where hydrocarbons are reformed to produce hydrogen.

### BACKGROUND OF THE INVENTION

Growing concerns over greenhouse gas emissions and air pollution emanating from energy usage and over the long-term availability of fossil fuels and energy supply security drive the search for alternative energy sources and energy vectors. Hydrogen has emerged as the preferred new energy vector since it addresses all these concerns. It can be used in both internal combustion engines and fuel cells for both stationary and mobile applications of any size. Particularly, its usage in fuel cells to produce electricity or to co-generate heat and electricity represents the most environment friendly energy production process due to the absence of any pollutant emissions. Furthermore, hydrogen can be produced from abundant and local renewable energy sources such as biofuels, solar or wind providing for secure and sustainable energy availability.

The critical questions for the successful implementation of hydrogen as an energy vector are its sourcing and distribution. Hydrogen has been produced at large scale for many decadesin refineries and chemical plants. Its successful introduction into the transportation and distributed energy production sectors, however, requires the establishment of sufficient refueling and distribution networks. Hydrogen transportation is very inefficient and expensive due to its low energy density in its usual form. Even when hydrogen is compressed or liquefied, its transportation requires specialized and bulky equipment that minimizes the amount that can be safely carried, increasing resource consumption and cost. This issue can become insurmountable in the early stages of the implementation when demand will be low and not able to justify costly infrastructure options such as pipeline networks. The only feasible option will then be distributed hydrogen production facilities.

Numerous proposals for distributed hydrogen production facilities ranging in capacity from a few Nm³/h to a few hundred Nm³/h are in the research and development phases and a few have been already implemented. Even though such facilities are much smaller than the ones employed in the refineries and the chemical plants, they are based on the same process technologies and involve hydrogen production by the reformation of hydrocarbon fuels. These proposals take advantage of the well established distribution network of such fuels to address the raw material availability concerns. The fuels most commonly mentioned include natural gas, propane, butane (LPG) and ethanol as the representative of the biofuels. They can be reformed according to the reactions:

CH₄+H₂O→CO+3H₂ ΔH=49.3 kcal/mol

C₃H₈+3H₂O—+3CO+7H₂ ΔH=119.0 kcal/mol

C₄H₁₀+4H₂O→4CO+9H₂ ΔH=155.3 kcal/mol

C₂H₅OH+H₂O→2CO+4H₂ ΔH=57.2 kcal/mol

The reforming reactions are highly endothermic, as indicated by the heats of reactions (ΔH), requiring substantial amounts of heat input typically covered by an external heat supply. Since these reactions take place at temperatures in the range of 700-900° C., the demand for heat input is enlarged by the need to heat up the reactants. The technique typically employed is to place the catalyst containing tubes of the reactor inside a fired furnace which provides the necessary heat. This is a rather inefficient arrangement due to the severe heat transfer limitations that exist and the metallurgical limits that must be observed. A more efficient reactor configuration must be employed.

The products of the reforming reactions can yield substantial additional amounts of hydrogen by the water-gas-shift (WGS) reaction:

CO+H₂O→CO₂+H₂ ΔH=−9.8 kcal/mol

This reaction is typically carried out in two reactors: one high temperature (250-450° C.) that takes advantage of the higher reaction rates at higher temperatures and a low temperature (150-300° C.) on that takes advantage of the more favorable thermodynamic equilibrium and lowers the amount of CO present in the product stream to about 1%. When very low concentrations of CO are required, as when the product will feed a low temperature fuel cell, a selective CO oxidation or a methanation reaction takes place in a subsequent reactor that operates at low temperatures (120-250° C.) and lowers the CO amount to a few ppm.

What is evident from the above is that production of hydrogen to feed a fuel cell requires a series of reactors that operate at vastly different temperature ranges. Heat management and optimization become, then, critical issues for distributed hydrogen generation systems and must be addressed with novel, highly heat integrated fuel processor configurations such as the ones of the present invention.

### BRIEF DESCRIPTION OF THE INVENTION

The present invention relates to a fuel processor that produces a hydrogen rich stream suitable to feed low temperature fuel cells by the process known as steam reforming of hydrogen containing compounds. The fuel processor is comprised of four reactors and a multitude of heat exchangers so as to achieve a very high degree of heat integration and very high efficiency. To further increase efficiency, the reforming reactor is of a heat exchanger type comprised of a reformer/combustor assembly where the two sections are separated by a thin metal partition and are in thermal contact as to facilitate the efficient transfer of heat from the combustion to the reforming section. All four reactors and several of the heat exchangers can be placed inside a single shell, resulting in a very compact fuel processor well suited for distributed hydrogen generation. Combustion is mostly catalytic and takes place over a suitable catalyst. Steam reforming is a catalytic reaction and takes place over another suitable catalyst.

In one aspect, the present invention relates to a fuel processor for producing hydrogen from a fuel source. The fuel processor comprises a heat integrated combustor/steam reformer assembly. A fuel and steam mixture is supplied to the reformer to be reformed and a fuel and air mixture is supplied to the combustor to be corn busted. The fuel processor also comprises a high temperature WGS reactor, a low temperature WGS reactor and a methanation reactor. The fuel processor further comprises a series of heat exchangers to exchange heat between different streams of the process.

As a feature, the integrated combustor/steam reformer assembly includes a multitude of tubular sections defined by cylindrical walls separated from each other and supported on each end on plates machined as to allow the cylindrical walls to pass through them and to be in fluid connection with only one side of the plate. The inside wall of the tubular sections is coated with a catalyst that includes the desired reaction in the combustor feed. The outside wall of the tubular sections is coated with a catalyst that induces the desired reaction in the reformer feed. The assembly also includes an appropriately shaped reactor head that facilitates the introduction and distribution of the fuel and air mixture inside the tubular sections while it isolates the space defined between the plate and the reactor head from being in fluid connection with the surroundings. The assembly further includes an appropriately shaped reactor head that facilitates the collection and exit of the combustion products. The assembly space defined between the opposite plates and the external surfaces of the tubular sections is the reforming part of the assembly and is in fluid contact with other parts of the fuel processor allowing the introduction of the fuel and steam mixture in the reforming section and the removal of the products of the reforming reactions.

As another feature, the combustor products are fed to a heat exchanger where they exchange heat with the reformer feed. The pre-heated feed is then fed to the reforming section.

According to another feature, the products of the reforming reaction (reformate) exchange heat with the feed to the reformer in a heat exchanger placed after the exit of the reforming section.

According to yet another feature, the reformate exchanges heat in a steam generator where steam is produced for the feed to the reformer. The reformate then enters the high temperature WGS reactor where most of the CO reacts and produces more hydrogen.

According to yet another feature, the reformate exchanges heat in a steam generator where steam is produced for the feed to the reformer. The reformate then enters the low temperature WGS reactor where most of the remaining CO reacts and produces more hydrogen.

According to yet another feature, the reformate exchanges heat with process water in a heat exchanger. The reformate then enters the CO selective oxidation reactor where most of the remaining CO reacts.

According to yet another feature, the CO selective oxidation reactor is replaced by a methanation reactor where most of the remaining CO reacts.

According to yet another feature, the reformate exchanges heat with process water in a heat exchanger before it exists the fuel processor.

According to yet another feature, the fuel processor comprises a separator vessel where water condensed from the reformate is separated from the gaseous part of the reformate and is returned to the process.

In another aspect of the present invention, the fuel processor comprises a heat exchanger where heat is exchanged between the combustor products and the fuel that is fed to the reformer.

According to another feature, the fuel processor comprises a heat exchanger where heat is exchanged between the combustor products and process water to produce steam for the feed to the reformer.

According to yet another feature, the fuel processor comprises a heat exchanger where heat is exchanged between the combustor products and the air that is fed to the combustor.

According to yet another feature, the fuel processor comprises a heat exchanger where heat is exchanged between the combustor products and process water.

According to yet another feature, the fuel processor comprises a separator vessel where water condensed from the combustor products is separated from the gaseous part of the products and is returned to the process.

These and other features and advantages of the present invention will become apparent from the following description of the invention and the associated drawings.

### BRIEF DESCRIPTION OF THE DRAWINGS

FIG. 1 illustrates the fuel processing system embodying the invention.

FIG. 2 illustrates the integrated reformer/combustor assembly of the invention.

FIG. 3A is a flow schematic showing the fluid flows through the fuel processor according to one embodiment of the heat integrated fuel processor of the invention.

FIG. 3B is a flow schematic showing the fluid flows through the fuel processor according to another embodiment of the heat integrated fuel processor of the invention.

### DETAILED DESCRIPTION OF THE PREFERRED EMBODIMENTS

The present invention is described in detail with reference to a few preferred embodiments illustrated in the accompanying drawings. The description presents numerous specific details included to provide a thorough understanding of the present invention. It will be apparent, however, to one skilled in the art that the present invention can be practiced without some or all of these specific details. On the other hand, well known process steps, procedures and structures are not described in detail as to not unnecessarily obscure the present invention.

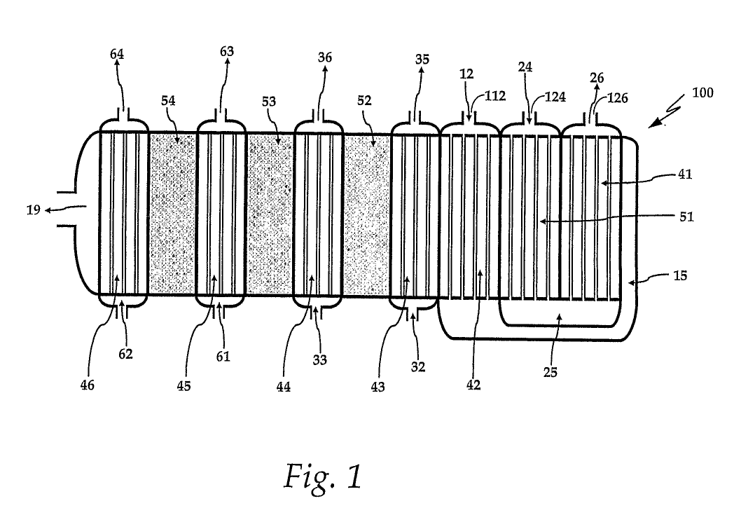

FIG. 1 illustrates the heat integrated fuel processor 100 according to one embodiment of the present invention. The fuel processor assembly includes a flow passage 112 where a fuel and steam mixture entering at a temperature 120-400° C. is supplied to heat exchanger 42 where it is preheated to 300-700° C. by the reformate exiting the reformer/combustor assembly 51. The preheated fuel and steam mixture is transferred through flow passage 14 to heat exchanger 41 where it is further preheated to 600-900° C. by the products of the combustor. The said preheated fuel and steam mixture enters the reforming section of the reformer/combustor assembly 51 where the desired reactions are induced by a catalyst. The reformer products exit assembly 51 at 600-850° C. and transfer part of their heat to the fuel steam mixture in heat exchanger 51 where they are cooled down to 400-700° C. The reformer products are farther cooled down to 280-400° C. by providing the necessary heat for steam generation in steam generator 43.

The reformate exiting steam generator 43 enters the high temperature WGS reactor 52 where most of the CO contained in the stream is converted to CO₂ by the water-gas-shift reaction.

The WGS reaction is exothermic, so the products exit reactor 52 at 300-500° C. They are cooled down to 150-300° C. by providing the necessary heat for steam generation in steam generator 44.

The high temperature WGS products exiting steam generator 44 enter the low temperature WGS reactor 53 where most of the CO remaining in the stream is converted to CO₂ by the water-gas-shift reaction. The WGS reaction is exothermic, so the products exit reactor 53 at 160-350° C. They are cooled down to 100-200° C. in heat exchanger 45 where they exchange heat with process water providing hot process water.

The low temperature WGS products exiting heat exchanger 45 enter the CO selective oxidation reactor 54 where most of the CO remaining in the stream is combusted to CO₂. The selective oxidation reaction is exothermic, so the products exit reactor 54 at 120-250° C. They are cooled down to 60-80° C. in heat exchanger 46 where they exchange heat with process water providing hot process water.

In another embodiment of the present invention, the selective CO oxidation reactor 54 is replaced with a methanation reactor where most of the CO contained in the stream exiting the low temperature WGS reactor is converted to CH₄ by the methanation reaction.

The fuel processor assembly also includes a flow passage 124 where a fuel and air mixture is supplied to the combustion section of the integrated reformer/combustor assembly 51. The fuel is combusted over a catalyst that induces the desired reaction in the combustor feed. The combustor products exit through flow passage 25 and feed heat exchanger 41 where they exchange heat with the feed to the reformer. They, then, exit the fuel processor through flow passage 126.

In one embodiment of the present invention, reactors 51, 52, 53 and 54 and heat exchangers 41, 42, 45 and 46 and steam generators 43 and 44 arranged as shown in FIG. 1 can be housed in a single shell forming a compact and very efficient unit. A cylindrical shell 60 cm high and 30 cm in diameter is sufficient to house a unit with a hydrogen production capacity of 15 Nm³/h.

In another embodiment of the present invention, heat exchanger 45 and 46 and reactor 54 can be placed in a second, separate shell to allow for greater flexibility in packaging the fuel processor as for example for mobile applications.

In yet another embodiment of the present invention, the fuel processor can produce hydrogen for a higher temperature fuel cell that can tolerate CO concentrations of approximately 1%. In this embodiment, reactor 54 and heat exchanger 46 are completely removed from the fuel processor while all other parts are assembled in the manner described previously.

In yet another embodiment of the present invention, the fuel processor can produce hydrogen for a higher temperature fuel cell that can tolerate CO concentrations of approximately 3-4% or the fuel processor can be connected to a hydrogen purification system such as a Pressure Swing Adsorption (PSA) unit. In this embodiment, reactors 54 and 53 and heat exchangers 45 and 46 are completely removed from the fuel processor while all other parts are assembled in the manner described previously.

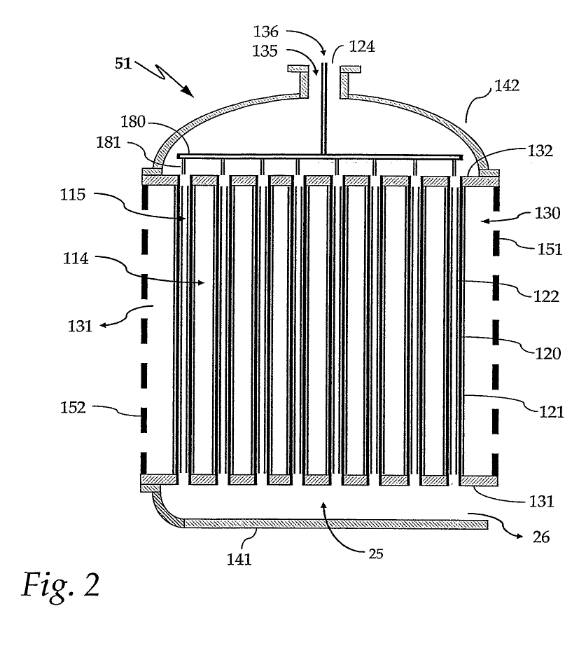

FIG. 2 presents in more detail one embodiment of the integrated reformer/combustor assembly of the invention. The assembly 51 comprises a multitude of tubular sections 120 separated from each other and supported on each end on tube sheets 131 and 132 machined as to allow the cylindrical walls to pass through them and to be in fluid connection with only one side of the sheet. The inside wall of the tubular sections is coated with a catalyst 122 that induces the desired reaction in the combustor feed. The total space inside the tubular sections 120 defines the combustion zone 115 where the majority of the combustion reactions take place. The assembly also includes an appropriately shaped reactor head 142 connected to tubesheet 132 and having a flow passage 124 so that it facilitates the introduction and distribution of the fuel and air mixture 24 inside the tubular sections 120 while it isolates the space defined between the plate 132 and the reactor head 142 from being in fluid connection with the surroundings. The assembly further includes a flow passage 141 that facilitates the collection of the combustion products 26 and directs them to heat exchanger 41 through the flue gas return line 25.

The outside wall of the tubular sections 120 is coated with a catalyst 121 that induces the desired reaction in the reformer feed 130 coming from heat exchanger 41 and directed by the distributor plate 151. The products of the reforming reactions are collected by collector plate 152 and are driven to heat exchanger 42. The assembly space defined between the opposite tube sheets 131 and 132 and between the distributor plate 151 and the collector plate 152 and the external surfaces of the tubular sections is the reforming zone 114 of the assembly where the reforming reactions take place. In the preferred embodiment of the present invention, the reforming reactions take place on the catalyst film 121 coating the tubular sections 120. The advantage of the present invention is the high degree of heat integration between the reformer and the combustor since heat is only transported across the wall of tubular section 120 minimizing heat transfer resistances and maximizing heat utilization.

In another embodiment, the reforming zone 114 can be filled with catalyst that induces the desired reaction in the reformer feed 130.

Since the tubes 120 and tube sheet 132 become very hot during operation, combustion can be initiated on the front surface of tube sheet 132 and back propagate through reactor head 142 and, possibly, through flow passage 124 if the fuel and air are pre-mixed. To avoid such a potentially very dangerous situation, the air and fuel can be kept separated until they enter the tubes 120 where combustion is desired. Air 135 enter the reactor head 142 through flow passage 124, gets distributed and uniformly enters the tubes 120 through tube sheet 132. Fuel 136 enters through a manifold 180 passing through flow passage 142 and placed adjacent to tube sheet 132 and is distributed to each tube through appropriately sized and shaped tips 181. Adjusting the relative flows of air and fuel, combustion can be moved inside the tubes.

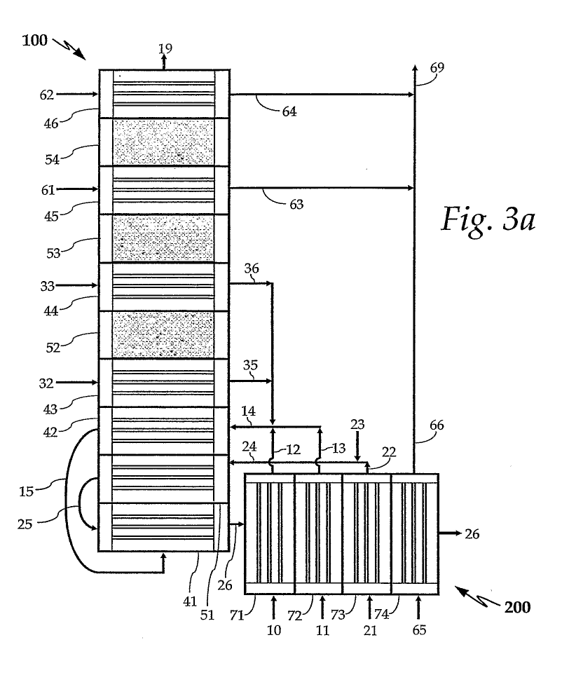

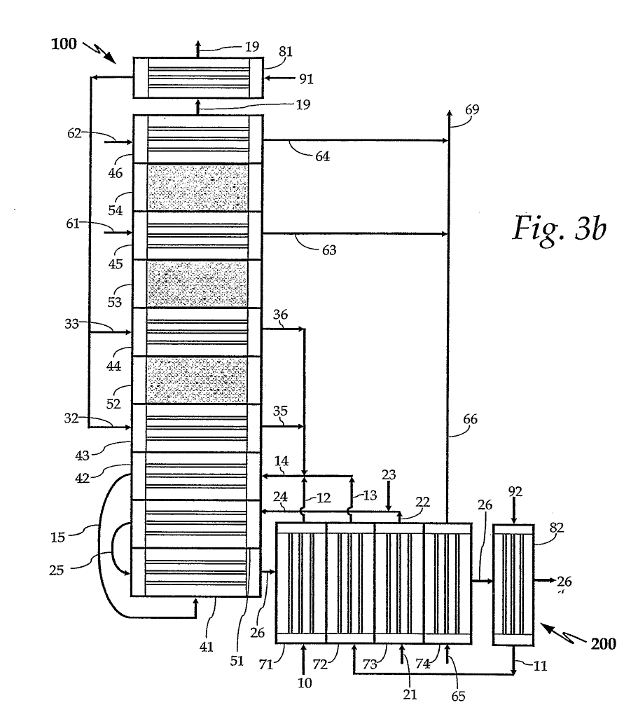

FIG. 3A presents a flow schematic for the fluid flows in one embodiment of the present invention. The fluid flows in the fuel processor 100 are the same as those presented in FIG. 1. The unit is farther heat integrated by employing a multi heat exchanger assembly 200 which utilizes the enthalpy of the flue gas stream to heat different process streams. The flue gas 26 exiting the reformer/combustor assembly 51 feeds the series of heat exchangers 71, 72, 73 and 74. Heat exchanger 71 receives as the cold stream the feed stream 10 and outputs the evaporated and preheated feed stream 12. Heat exchanger 72 receives de-ionized water 11 as the cold stream and outputs steam 13. Streams 12 and 13 are combined with streams 35 and 36 coming from steam generators 43 and 44 respectively. The combined stream is the feed to the reformer stream 14 which is fed to heat exchanger 42 to get further preheated.

Heat exchanger 73 receives air 21 as the cold stream and outputs preheated air 22. Preheated air 22 is combined with fuel 23 and supplies the feed to the combustor. Fuel 23 may be the same fuel being reformed or any other suitable fuel. In one embodiment of the present invention, fuel 23 comprises the anode gas exiting the fuel cell when the fuel processor is coupled to a fuel cell for the production of heat and power. In another embodiment of the present invention, fuel 23 comprises the tail gas of the PSA or similar unit when the fuel processor is coupled to such a unit for the production of high purity hydrogen.

Heat exchanger 74 receives cold process water 65 as the cold stream and outputs hot process water 66. This is combined with hot process water streams 63 and 64 exiting heat exchangers 45 and 46 respectively. The combined stream 69 provides hot process water at temperatures of 50-80° C. and constitutes the useable heat production of the CHP unit. A properly designed heat exchanger assembly 200 can receive flue gas at temperatures of 500-900° C. and output the flue gas at temperatures below 50° C.

In another embodiment of the present invention, heat exchangers 46 and 74 receive ambient or cold air as the cold stream and output hot air for heating purposes.

In yet another embodiment of the present invention, when the heat output of the fuel processor can not be utilized, heat exchangers 46 and 74 are omitted.

FIG. 3B presents a flow schematic for the fluid flows in another embodiment of the present invention where water recirculation is used to decrease the water demand of the fuel processor. The steam reforming employed as the preferred hydrogen production reaction requires substantial amounts of water to be supplied along with the fuel. The benefit is that a large portion of the hydrogen is produced from the water, i.e. water acts as fuel in this process. This, however, places significant demands on the water supply to the unit and may limit its applicability to areas where water constraints exist. To overcome this, part of the water exiting the fuel processor is collected, re-circulated and re-used in the fuel processor.

When the reformate 19 is cooled to below 100° C. in heat exchanger 46, part of the water present in the reformate is condensed as to establish a thermodynamic equilibrium. This condensed water is separated in the aerated separator 81. Additional water 91 may be fed to the separator to enhance the separation and to provide the total amount of water required to form streams 32 and 33 that feed the steam generators 42 and 44.

When the flue gas 26 is cooled to below 100° C. in heat exchanger 74, part of the water present in the flue gas is condensed as to establish a thermodynamic equilibrium. This condensed water is separated in the aerated separator 82. Additional water 92 may be fed to the separator to enhance the separation and to provide the total amount of water required to form stream 11 that feeds steam generator 72.

While this invention has been described in terms of several preferred embodiments, there are alterations, permutations and equivalents that fall within the scope of the present invention and have been omitted for brevity. It is therefore intended that the scope of the present invention should be determined with reference to appended claims.

1. A fuel processor for the production of hydrogen from a fuel source, the fuel processor comprising within a single housing:
an integrated steam reformer/combustor assembly configured to receive a steam/fuel feed mix to be reformed in said assembly and an air/fuel mix to be combusted in said assembly;
a heat exchanger placed before and in fluid connection with said assembly configured to receive the combustion products and transfer heat to the reformer feed;
a heat exchanger placed after and in fluid connection with said assembly configured to receive the reforming products and transfer heat to the reformer feed;
a steam generator receiving heat from the reforming products and generating steam;
a reactor where the water gas shift reaction takes place at temperatures of 250-500° C.;
a steam generator receiving heat from the water gas shift reaction products and generating steam;
a reactor where the water gas shift reaction takes place at temperatures of 150-400° C.;
a heat exchanger cooling the water gas shift reaction products;
a reactor where the selective CO oxidation or methanation reactions take place;
a heat exchanger cooling the selective CO oxidation or methanation reaction products;

2. The fuel processor of claim 1 where the selective CO oxidation or methanation reactor and the heat exchanger cooling the selective CO oxidation or methanation reaction products are placed in a different housing or housings.

3. The fuel processor of claim 1 where the heat exchanger cooling the water gas shift reaction products, the selective CO oxidation or methanation reactor and the heat exchanger cooling the selective CO oxidation or methanation reaction products are placed in a different housing or housings.

4. The fuel processor of claim 1 where the low temperature water gas shift reactor, the heat exchanger cooling the water gas shift reaction products, the selective CO oxidation or methanation reactor and the heat exchanger cooling the selective CO oxidation or methanation reaction products are placed in a different housing or housings.

5. The fuel processor of claim 1 where the steam generator cooling the reforming products, the high temperature water gas shift reactor, the steam generator cooling the high temperature water gas shift reaction products, the low temperature water gas shift reactor, the heat exchanger cooling the water gas shift reaction products, the selective CO oxidation or methanation reactor and the heat exchanger cooling the selective CO oxidation or methanation reaction products are placed in a different housing or housings.

6. A fuel processor for the production of hydrogen from a fuel source, the fuel processor comprising within a single housing:
an integrated steam reformer/combustor assembly configured to receive a steam/fuel feed mix to be reformed in said assembly and an air/fuel mix to be combusted in said assembly;
a heat exchanger placed before and in fluid connection with said assembly configured to receive the combustion products and transfer heat to the reformer feed;
a heat exchanger placed after and in fluid connection with said assembly configured to receive the reforming products and transfer heat to the reformer feed;
a steam generator receiving heat from the reforming products and generating steam;
a reactor where the water gas shift reaction takes place at temperatures of 250-500° C.;
a steam generator receiving heat from the water gas shift reaction products and generating steam;
a reactor where the water gas shift reaction takes place at temperatures of 150-400° C.;
a heat exchanger cooling the water gas shift reaction products.

7. A fuel processor for the production of hydrogen from a fuel source, the fuel processor comprising within a single housing:
an integrated steam reformer/combustor assembly configured to receive a steam/fuel feed mix to be reformed in said assembly and an air/fuel mix to be combusted in said assembly;
a heat exchanger placed before and in fluid connection with said assembly configured to receive the combustion products and transfer heat to the reformer feed;
a heat exchanger placed after and in fluid connection with said assembly configured to receive the reforming products and transfer heat to the reformer feed;
a steam generator receiving heat from the reforming products and generating steam;
a reactor where the water gas shift reaction takes place at temperatures of 250-500° C.;
a steam generator receiving heat from the water gas shift reaction products and generating steam.

8. A fuel processor for the production of hydrogen from a fuel source, the fuel processor comprising within a single housing:
an integrated steam reformer/combustor assembly configured to receive a steam/fuel feed mix to be reformed in said assembly and an air/fuel mix to be combusted in said assembly;
a heat exchanger placed before and in fluid connection with said assembly configured to receive the combustion products and transfer heat to the reformer feed;
a heat exchanger placed after and in fluid connection with said assembly configured to receive the reforming products and transfer heat to the reformer feed;

9. The fuel processor of claim 1 further comprising a heat exchanger transferring heat between the combustion products and the fuel feed to the reformer.

10. The fuel processor of claim 9 further comprising a heat exchanger transferring heat from the combustion products and generating steam.

11. The fuel processor of claim 10 further comprising a heat exchanger transferring heat between the combustion products and the air feed to the combustor.

12. The fuel processor of claim 11 further comprising a heat exchanger transferring heat between the combustion products and water or air to produce higher temperature water or air.

13. The fuel processor of claim 12 further comprising a separator separating any condensed water for the cooled combustion products and recycling said water back to the process.

14. The fuel processor of claim 13 further comprising a separator separating any condensed water for the cooled reforming products and recycling said water back to the process.

15. The fuel processor of claim 1 further comprising a separator separating any condensed water for the cooled reforming products and recycling said water back to the process.
